(19) United States
(12) Patent Application Publication
(10) Pub. No.: US 2012/0168500 A1
(43) Pub. Date: Jul. 5, 2012

(54) IC Card and IC Card Security Authentication System

(76) Inventor: Syue-Min Li, Taipei City (TW)

(21) Appl. No.: 13/334,198

(22) Filed: Dec. 22, 2011

(30) Foreign Application Priority Data
Dec. 31, 2010 (TW) 099147429

(51) Int. Cl. G06K 5/00

(52) U.S. Cl. 235/382

(57) ABSTRACT

An integrated circuit (IC) card is adapted for exchanging data with an external computer device, and includes an IC chip for storing owner fingerprint data, a fingerprint scanner, and a control unit coupled electrically to the IC chip and the fingerprint scanner. The control unit includes a central processing unit operatively associated with the IC chip and the fingerprint scanner. The central processing unit is configured to compare user fingerprint data inputted via the fingerprint scanner with the owner fingerprint data stored in the IC chip, and to enable the control unit to conduct a transaction with the external computer device when the user fingerprint data matches the owner fingerprint data.

### CROSS-REFERENCE TO RELATED APPLICATION

This application claims priority of Taiwanese Application No. 099147429, filed on Dec. 31, 2010.

### BACKGROUND OF THE INVENTION

1. Field of the Invention

The present invention relates to an integrated circuit (IC) card, more particularly to an IC card capable of identity identification and to an IC card security authentication system.

2. Description of the Related Art

With development and advancement of technology, plastic money, such as a credit card, a bank card, or a card for micropayment, is becoming more popular. The plastic money is convenient to use, but a card holder is under a risk of fraudulent purchases when the plastic money is misplaced. Therefore, if a chance that a non-owner is able to use the plastic money is lowered, the risk of fraudulent purchases of the card holder may then be reduced. Moreover, data may be intercepted during transmission. Therefore, when the data are not usable by others even if the data are intercepted during transmission, security of transaction using the plastic money may be promoted.

Furthermore, a card, such as a health insurance card or an access card, is also prone to be fraudulently used, such that further improvements are needed.

### SUMMARY OF THE INVENTION

Therefore, an object of the present invention is to provide an integrated circuit (IC) card capable of identity identification, and to provide an IC card security authentication system.

In a first aspect of the present invention, the IC card is adapted for exchanging data with an external computer device, and comprises a card body, an IC chip, a fingerprint scanner, and a control unit. The card body has a surface. The IC chip is disposed on the surface of the card body for storing owner fingerprint data. The fingerprint scanner is disposed on the surface of the card body. The control unit is disposed at the card body, and is coupled electrically to the IC chip. The control unit includes a central processing unit, and a communication module. The central processing unit is operatively associated with the IC chip and the fingerprint scanner. The communication module is operatively associated with the central processing unit and is configured for communicating with the external computer device. The central processing unit is configured to compare user fingerprint data inputted via the fingerprint scanner with the owner fingerprint data stored in the IC chip, and to enable the control unit to conduct a transaction with the external computer device when the user fingerprint data matches the owner fingerprint data.

In a second aspect of the present invention, the IC card security authentication system comprises an IC card and a computer device for exchanging data with the IC card. The IC card includes a card body, an IC chip, a fingerprint scanner, and a control unit. The card body has a surface. The IC chip is disposed on the surface of the card body for storing owner fingerprint data. The fingerprint scanner is disposed on the surface of the card body. The control unit is disposed at the card body and is coupled electrically to the IC chip and the fingerprint scanner. The control unit includes a central processing unit, and a communication module. The central processing unit is operatively associated with the IC chip and the fingerprint scanner. The communication module is operatively associated with the central processing unit and is configured for communicating with the computer device. The central processing unit is configured to compare user fingerprint data inputted via the fingerprint scanner with the owner fingerprint data stored in the IC chip, and to enable the control unit to conduct a transaction with the computer device when the user fingerprint data matches the owner fingerprint data.

The computer device includes a memory, a facial feature capturing device, a device fingerprint scanner, and a device control circuit. The memory stores the owner fingerprint data and owner facial feature data. The facial feature capturing device is for capturing user facial feature data. The device control circuit is coupled electrically to the memory, the facial feature capturing device, and the device fingerprint scanner. The device control circuit is operable in at least one of a fingerprint matching mode and a facial feature matching mode. In the fingerprint matching mode, the device control circuit is configured to compare user fingerprint data inputted via the device fingerprint scanner with the owner fingerprint data stored in the memory, and to enable the computer device to conduct the transaction with the IC card when the user fingerprint data inputted via the device fingerprint scanner matches the owner fingerprint data stored in the memory. In the facial feature matching mode, the device control circuit is configured to compare the user facial feature data captured by the facial feature capturing device with the owner facial feature data stored in the memory, and to enable the computer device to conduct the transaction with the IC card when the user facial feature data matches the owner facial feature data.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating a preferred embodiment of an IC card of the present invention;

FIG. 2 is a block diagram of the preferred embodiment of the IC card of the present invention;

FIG. 3 is a flow chart illustrating an authentication process of the preferred embodiment of the IC card according to the present invention;

FIG. 4 is a flow chart illustrating another authentication process of the preferred embodiment of the IC card according to the present invention;

FIG. 5 is a perspective view of a computer device in a preferred embodiment of an IC card security authentication system according to the present invention;

FIG. 6 is a block diagram of the computer device illustrated in FIG. 5;

FIG. 7 is a perspective view of a monitor in another preferred embodiment of the IC card security authentication system according to the present invention;

FIG. 8 is a schematic view illustrating another embodiment of the IC card of the present invention; and

FIG. 9 is a perspective view of an automatic teller machine (ATM) provided for use with the preferred embodiment of the IC card of the present invention.

### DETAILED DESCRIPTION OF THE PREFERRED EMBODIMENTS

Before the present invention is described in greater detail with reference to the preferred embodiments, it should be noted that the same reference numerals are used to denote the same elements throughout the following description. Moreover, to facilitate description of the features of the present invention, components in the drawings are not depicted in actual scale.

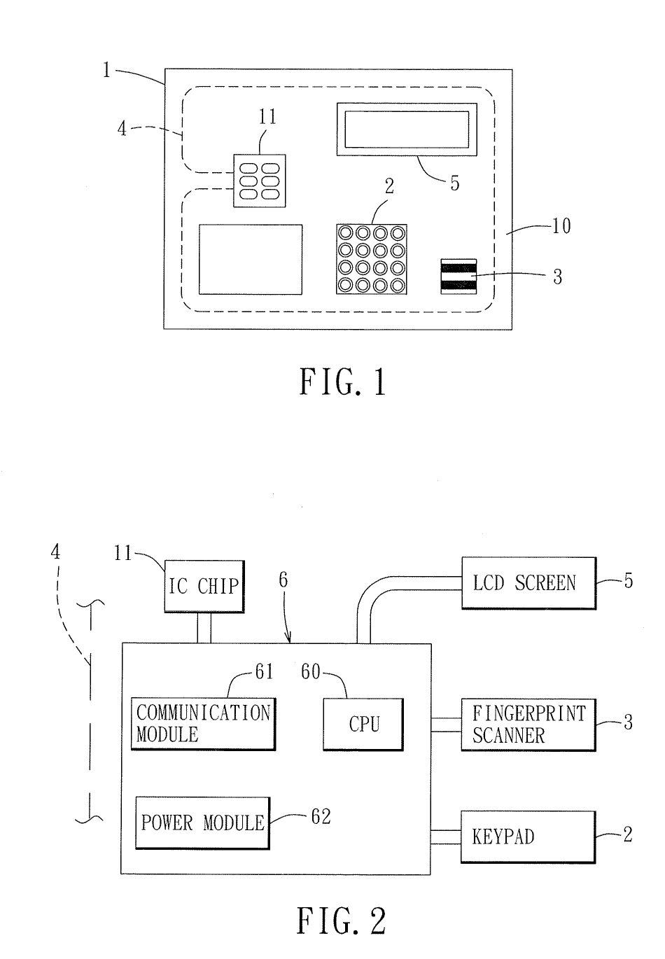

FIG. 1 is a schematic view illustrating a preferred embodiment of an IC card of the present invention. FIG. 2 is a block diagram for illustrating circuit components of the IC card.

Referring to FIG. 1 and FIG. 2, the preferred embodiment of the IC card, according to the present invention, is adapted for exchanging data with an external computer device. The IC card comprises a card body 1, an IC chip 11, a keypad 2, a fingerprint scanner 3, a radio frequency identification (RFID) antenna 4, a liquid crystal display (LCD) screen 5, and a control unit 6.

In this embodiment, the card body 3 is made of a material with a certain degree of flexibility such that the IC card may be prevented from fracture when slightly bent. Like conventional credit cards and bank cards, the card body 1 has a surface 10, and the IC chip 11 is disposed on the surface 10 of the card body 1. The IC chip 11 stores information such as owner account data, owner facial feature data, owner fingerprint data, an owner identity number, and an owner birth date.

The keypad 2 is disposed on the surface 10 of the card body 1, and is operable by a user for data input. It should be noted that, aside from numeric keys, the keypad 2 may include function keys such as a plus key, a minus key, a multiplication key, and a division key. Through operating the keypad 2, a transaction amount of the IC card is set, and is paid via a contact card reader or a contactless card reader. Moreover, a pas sword may be inputted though operating the keypad 2 for authentication with the external computer device (not shown).

The fingerprint scanner 3 is disposed on the surface 10 of the card body 1, and is operable for generating user fingerprint data through fingerprint scanning. By means of the fingerprint scanner 3 and the owner fingerprint data stored in the IC chip 11, the user may be relieved from inputting the password when using the IC card to conduct a transaction, such as a business to business (B to B) transaction, a business to consumer (B to C) transaction, a consumer to consumer (C to C) transaction, or a money transfer between bank accounts.

The RFID antenna 4 is disposed at the card body 1. In this embodiment, the RFID antenna 4 is preferably embedded in the card body 1, and through the RFID 4, the IC card is able to wirelessly exchange data with the external computer device.

The LCD screen 5 is disposed on the surface 10 of the card body 1, and is operable for displaying transaction information, such as accounts, transaction amounts, transaction status, etc. The LCD screen 5 is further operable for displaying each transaction amount, and a total transaction amount for a purpose of personal financial management.

In another embodiment, a display (not shown) is disposed on another surface of the card body 1 opposite to the surface 10 on which the IC chip 11 is disposed. The display is coupled electrically to the control unit 6 and is one of an organic electroluminescent (EL) display and an inorganic EL display.

The control unit 6 is disposed at the card body 1, and is coupled electrically to the IC chip 11, the fingerprint scanner 3, the keypad 2, the RFID antenna 4, and the LCD screen 5. The control unit 6 includes a central processing unit (CPU) 60 operatively associated with the IC chip 11 and the fingerprint scanner 3, a communication module 61 operatively associated with the central processing unit 60 and configured for communicating with the external computer device, and a power module 62 for providing power to the aforesaid components of the IC card. The power module 62 is preferably a battery, such as a button cell. In another configuration of this embodiment, the power module 62 may include a battery pack or a capacitor which is charged in one of a wired and wireless manner, such that when communicating with the external computer device in one of the wired and wireless manner, the power module 62 may receive and store electric power from the external computer device so as to provide power to the aforesaid components of the IC card.

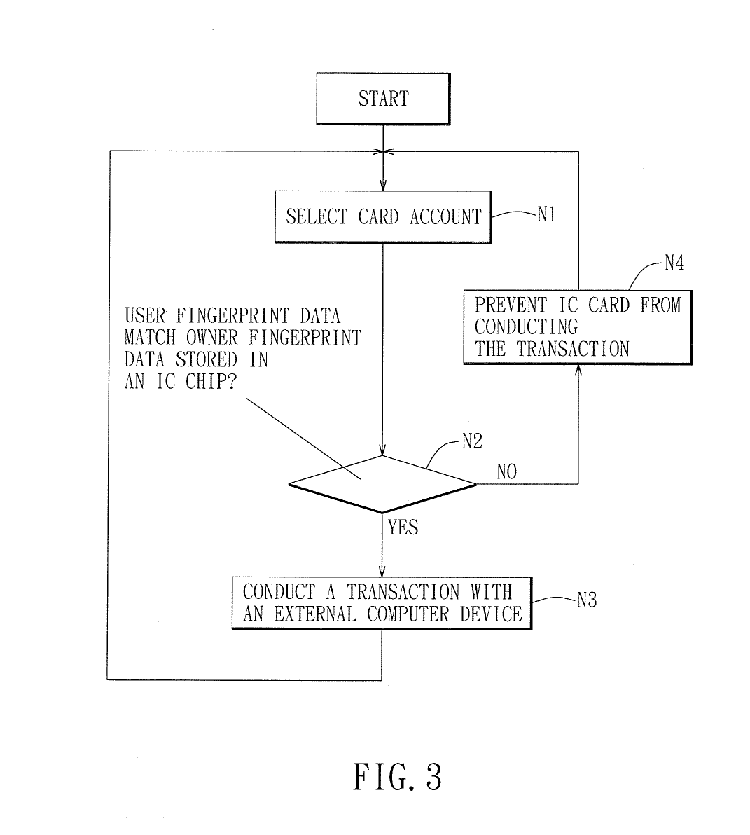

Referring to FIG. 3, a credit card is provided as an example for the preferred embodiment of the IC card according to the present invention, and an authentication process of the IC card is illustrated. In step N1, a credit card account is selected for transaction by the user via the keypad 2, and the central processing unit 60 of the IC card is configured to receive user fingerprint data inputted by the user via the fingerprint scanner 3. In step N2, the central processing unit 60 is configured to compare the user fingerprint data inputted via the fingerprint scanner 3 with the owner fingerprint data stored in the IC chip 11. In step N3, the central processing unit 60 is configured to enable the control unit 6 of the IC card to conduct a transaction with the external computer device when the user fingerprint data matches the owner fingerprint data. The transaction may include sending a valid code to the external computer device. Otherwise, in step N4, the central processing unit 60 is configured to prevent the control unit 6 from conducting the transaction with the external computer device when the user fingerprint data does not match the owner fingerprint data, and the flow goes back to step N1.

It should be noted that communication between the IC card and the external computer device may be achieved in one of a conventional contact style, and a contactless style via the RFID antenna 4. On the other hand, when the IC card stores only one card account, or when the card accounts are selectable through the external computer device, step N1 may be omitted.

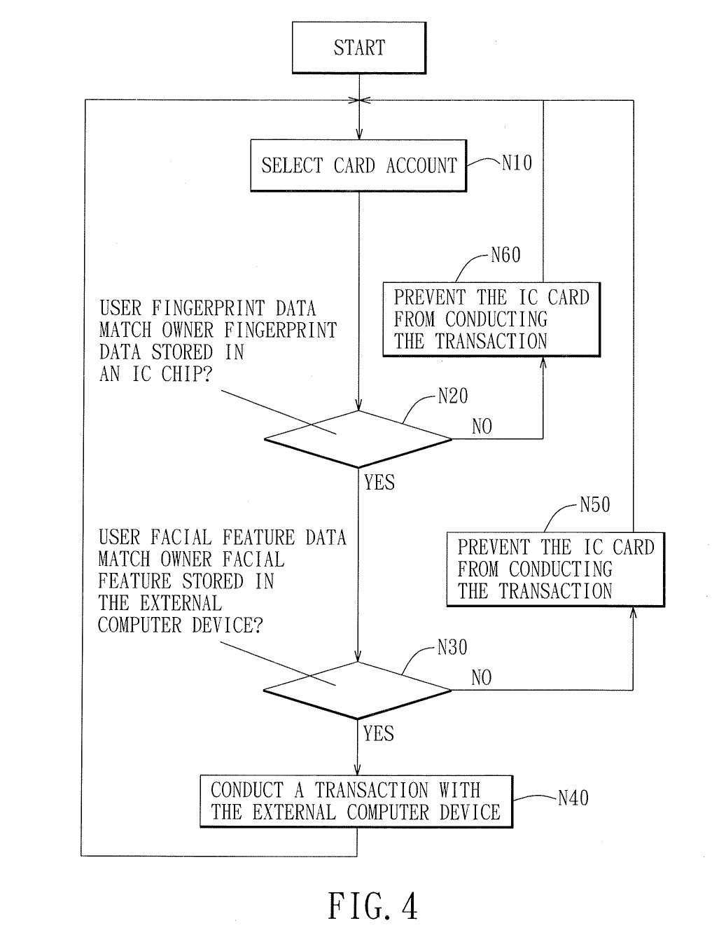

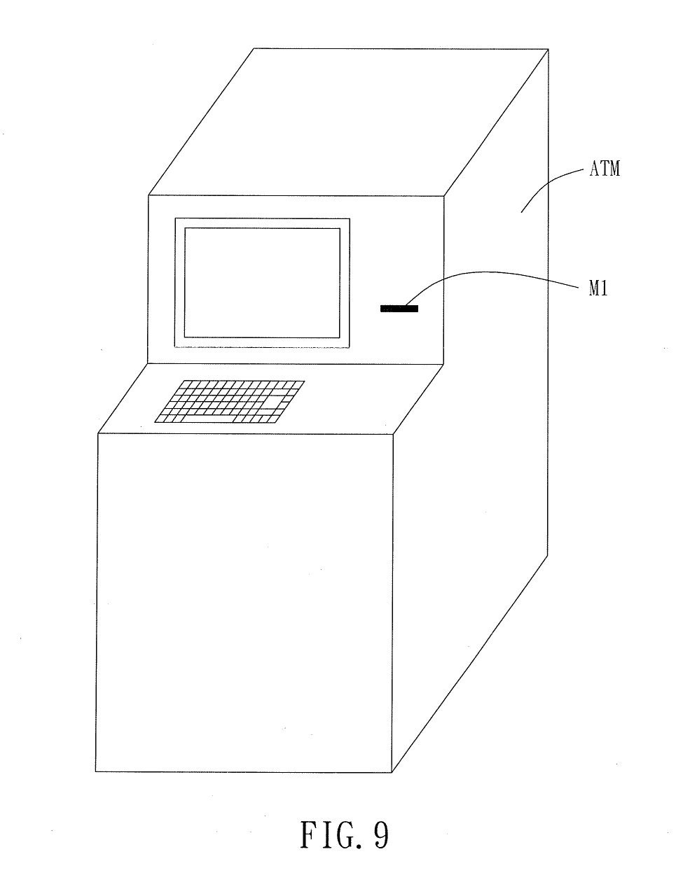

Referring to FIG. 4 and FIG. 9, a bank card is provided as an example for the preferred embodiment of the IC card according to the present invention. The IC card is used to conduct a transaction with an automatic teller machine (ATM) via an IC card interface Ml. Aside from a self-authentication process including steps N10 and N20 which are similar to steps N1 and N2 illustrated in FIG. 3, an external device authentication process may be performed after the self-authentication process is successfully completed. In step N30, a monitor (not shown) of the ATM is configured to capture user facial feature data, and the user facial feature data is compared with owner facial feature data stored in the ATM. In step N40, the ATM is enabled to transmit a permission code to the IC card for allowing the transaction with the IC card to be conducted when the user facial feature data matches the owner facial feature data. Otherwise, in step N50, the ATM is prevented from conducting the transaction with the IC card when the user facial feature data does not match the owner facial feature data, and the flow goes back to step N10.

It should be noted that, during transmission of the permission code, the permission code may be encoded with a transaction time code so as to form a one-time security code, such that fraudulent purchases may be prevented should the permission code be intercepted during transmission.

A dual authentication procedure including the aforesaid self-authentication process and the external device authentication process illustrated in FIG. 4 is also applicable to a transaction between a credit card and the external computer device (e.g., a credit card reader). Referring once again to FIG. 4, a credit card is provided as an example for the preferred embodiment of the IC card according to the present invention. In step N10, a credit card account is selected for transaction by the user via the keypad 2, and the central processing unit 60 of the IC card is configured to receive user fingerprint data inputted by the user via the fingerprint scanner 3. In step N20, the central processing unit 60 is configured to compare the user fingerprint data inputted via the fingerprint scanner 3 with the owner fingerprint data stored in the IC chip 11. Step N30 is performed when the user fingerprint data matches the owner fingerprint data. Otherwise, in step N60, the central processing unit 60 is configured to prevent the control unit 6 from conducting the transaction with the external computer device when the user fingerprint data does not match the owner fingerprint data, and the flow goes back to step N10.

After the self-authentication process of the IC card is successfully completed, the IC card is permitted to connect with the external computer device. At this time, in step N30, the external computer device is configured to ask the user to input the user fingerprint data once again, and the user fingerprint data is compared with the owner fingerprint data stored in the external computer device. In step N40, the external computer device is enabled to conduct the transaction with the IC card when the user fingerprint data matches the owner fingerprint data stored in the external computer device. Otherwise, in step N50, the external computer device is prevented from conducting the transaction with the IC card when the user fingerprint data does not match the owner fingerprint data stored in the external computer device, and the flow goes back to step N10.

In another configuration of this embodiment, in step 30, the external computer device is configured to capture user facial feature data of the user via a camera, and the user facial feature data is compared with owner facial feature data stored in the external computer device. In step 40, the external computer device is enabled to conduct the transaction with the IC card when the user facial feature data matches the owner facial feature data. Otherwise, in step N50, the external computer device is prevented from conducting the transaction with the IC card when the user facial feature data does not match the owner facial feature data, and the flow goes back to step N10.

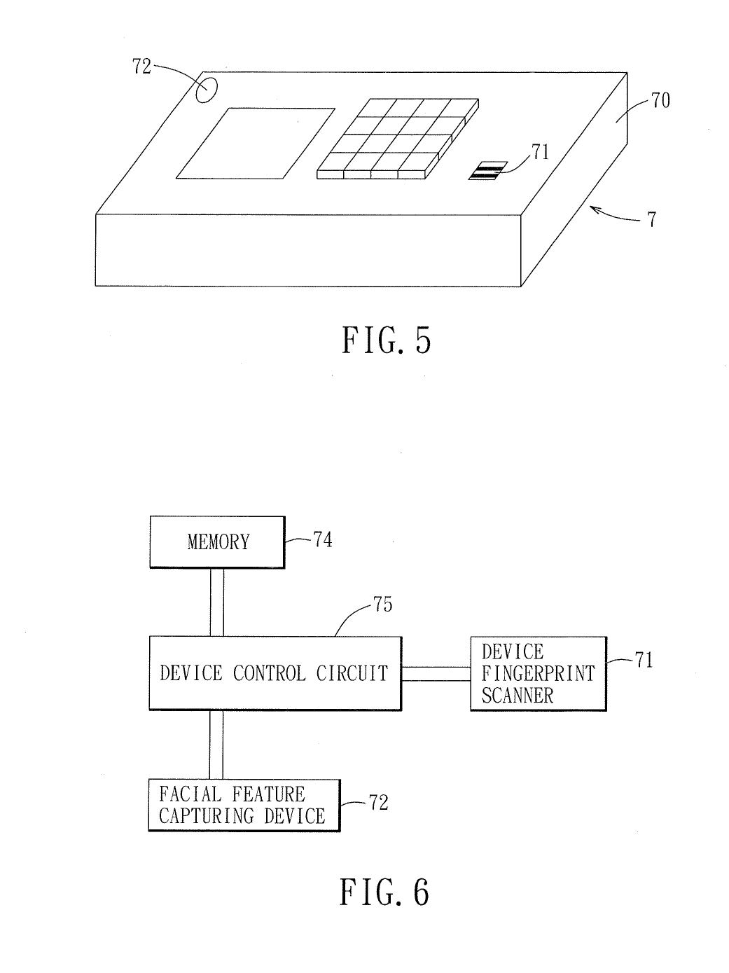

Referring to FIGS. 5 and 6, a computer device 7 (e.g., a credit card reader) in a preferred embodiment of an IC card security authentication system, according to the present invention, is illustrated.

The computer device 7 includes a device body 70, a device fingerprint scanner 71, a facial feature capturing device 72, a device control circuit 75 disposed in the device body 70 (see FIG. 6), and a memory 74 for storing the owner fingerprint data and the owner facial feature data. The facial feature capturing device 72 is for capturing user facial feature data. The device control circuit 75 is coupled electrically to the memory 74, the facial feature capturing device 72, and the device fingerprint scanner 71.

When the computer device 7 intends to conduct a transaction with a coupled IC card, the device control circuit 75 is operable in a fingerprint matching mode, in which the device control circuit 75 is configured to compare user fingerprint data inputted via the device fingerprint scanner 71 with the owner fingerprint data stored in the memory 74, and to enable the computer device 7 to conduct the transaction with the IC card when the user fingerprint data inputted via the device fingerprint scanner 71 matches the owner fingerprint data stored in the memory 74. Otherwise, the device control circuit 75 is configured to prevent the computer device 7 from conducting the transaction with the IC card when the user fingerprint data inputted via the device fingerprint scanner 71 does not match the owner fingerprint data stored in the memory 74.

Alternatively, the device control circuit 75 is further operable in a facial feature matching mode, in which the device control circuit 75 is configured to compare the user facial feature data captured by the facial feature capturing device 72 with the owner facial feature data stored in the memory 74, and to enable the computer device 7 to conduct the transaction with the IC card when the user facial feature data matches the owner facial feature data. Otherwise, the device control circuit 75 is configured to prevent the computer device 7 from conducting the transaction with the IC card when the user facial feature data does not match the owner facial feature data.

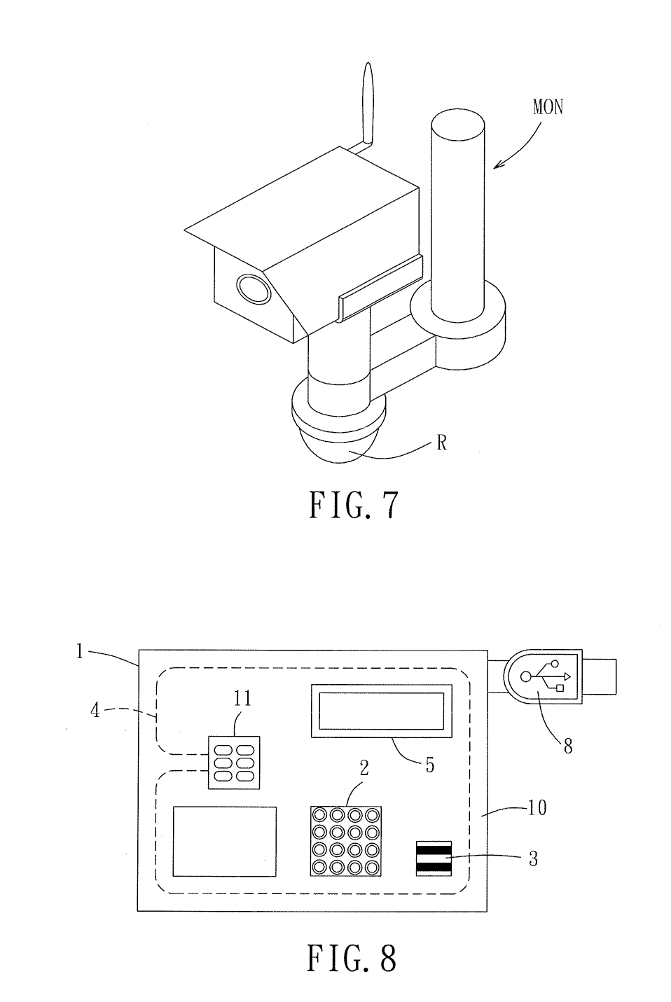

The IC card of the present invention is applicable to many situations where identity identification is required. Examples of such situation include an access card to VIP rooms of an airline company, a membership card or a discount card of a chain store, a room card of a hotel, an identification card of a company, an access card of an apartment, etc. By means of comparing the owner facial feature data stored in the computer device with the user facial feature data captured by a monitor NON (see FIG. 7) of the computer device which is provided with a 360-degree infrared scanning reader R, fraudulent use of the IC card may be immediately detected, and a warning or other proper response may be made. A health insurance card may likely adopt a design of the IC card of the present invention such that fraudulent use may be prevented by means of fingerprint authentication.

It should be noted that the IC card may be configured to conduct a transaction without authentication when the transaction amount is lower than a preset amount, so as to achieve an effect of convenience for micropayment applications.

Referring to FIG. 8, the IC card of the present invention may connect to a notebook computer or a desktop computer via a USB interface 8. The IC card is activated by means of fingerprint or password comparison, and may conduct one of an Internet transaction, such as a B to B transaction, a B to C transaction, or a C to C transaction, and a money transfer between bank accounts via a computer network to which the IC card is connected. It should be noted that USB interface 8 may be any plug-and-play USB interface adapted for connecting to an external computer device, such as a standard USB connector or a mini USB connector.

In summary, by means of the aforementioned authentication procedure, the IC card and the IC card security authentication system of the present invention may achieve an effect of reducing the risk of fraudulent purchase. Moreover, the permission code is encoded with the transaction time code so as to form the one-time security code, such that fraudulent purchases may be prevented should the permission code be intercepted during transmission.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An integrated circuit (IC) card adapted for exchanging data with an external computer device, said IC card comprising:
a card body having a surface;
an IC chip disposed on said surface of said card body for storing owner fingerprint data;
a fingerprint scanner disposed on said surface of said card body; and
a control unit disposed at said card body, coupled electrically to said IC chip and said fingerprint scanner, and including:
a central processing unit operatively associated with said IC chip and said fingerprint scanner; and
a communication module operatively associated with said central processing unit and configured for communicating with the external computer device;
wherein said central processing unit is configured to compare user fingerprint data inputted via said fingerprint scanner with the owner fingerprint data stored in said IC chip, and to enable said control unit to conduct a transaction with the external computer device when the user fingerprint data matches the owner fingerprint data.

2. The IC card as claimed in claim 1, further comprising a radio frequency identification (RFID) antenna disposed at said card body, coupled electrically to said control unit, and through which said control unit is able to wirelessly exchange data with the external computer device.

3. The IC card as claimed in claim 1, further comprising a liquid crystal display (LCD) screen disposed on said surface of said card body, coupled electrically to said control unit, and operable for displaying transaction information.

4. The IC card as claimed in claim 1, further comprising a keypad disposed on said surface of said card body, coupled electrically to said control unit, and operable for data input.

5. The IC card as claimed in claim 1, further comprising a display disposed on another surface of said card body opposite to said surface on which said IC chip is disposed, said display being coupled electrically to said control unit and being one of an organic electroluminescent (EL) display and an inorganic EL display.

6. The IC card as claimed in claim 1, further comprising a plug-and-play connector connected to said card body, coupled electrically to said control unit, and through which said control unit is able to exchange data with the external computer device in a wired manner.

7. The IC card as claimed in claim 1, wherein said control unit further includes a power module for providing power to said IC card.

8. The IC card as claimed in claim 1, wherein said central processing unit is configured to prevent said control unit from conducting a transaction with the external computer device when the user fingerprint data does not match the owner fingerprint data.

9. An integrated circuit (IC) card security authentication system comprising an IC card and a computer device for exchanging data with said IC card;
said IC card including: a card body having a surface; an IC chip disposed on said surface of said card body for storing owner fingerprint data; a fingerprint scanner disposed on said surface of said card body; and a control unit disposed at said card body and coupled electrically to said IC chip and said fingerprint scanner;
said control unit including: a central processing unit operatively associated with said IC chip and said fingerprint scanner; and a communication module operatively associated with said central processing unit and configured for communicating with said computer device;
said central processing unit being configured to compare user fingerprint data inputted via said fingerprint scanner with the owner fingerprint data stored in said IC chip, and to enable said control unit to conduct a transaction with said computer device when the user fingerprint data matches the owner fingerprint data.

10. The IC card security authentication system as claimed in claim 9, wherein said computer device includes:
a memory storing the owner fingerprint data and owner facial feature data;
a facial feature capturing device for capturing user facial feature data;
a device fingerprint scanner; and
a device control circuit coupled electrically to said memory, said facial feature capturing device, and said device fingerprint scanner;
wherein said device control circuit is operable in at least one of a fingerprint matching mode and a facial feature matching mode;
wherein, in the fingerprint matching mode, said device control circuit is configured to compare user fingerprint data inputted via said device fingerprint scanner with the owner fingerprint data stored in said memory, and to enable said computer device to conduct the transaction with said IC card when the user fingerprint data inputted via said device fingerprint scanner matches the owner fingerprint data stored in said memory;
wherein, in the facial feature matching mode, said device control circuit is configured to compare the user facial feature data captured by said facial feature capturing device with the owner facial feature data stored in said memory, and to enable said computer device to conduct the transaction with said IC card when the user facial feature data matches the owner facial feature data.

11. The IC card security authentication system as claimed in claim 10, wherein:
when said device control circuit is operated in the fingerprint matching mode, said device control circuit is configured to prevent said computer device from conducting the transaction with said IC card when the user fingerprint data inputted via said device fingerprint scanner does not match the owner fingerprint data stored in said memory; and
when said device control circuit is operated in the facial feature matching mode, said device control circuit is configured to prevent said computer device from conducting the transaction with said IC card when the user facial feature data does not match the owner facial feature data.
